(19) United States
(12) Patent Application Publication
(10) Pub. No.: US 2004/0137243 A1
(43) Pub. Date: Jul. 15, 2004

(54) Chemical vapor deposition of organosilicate thin films

(75) Inventors: Karen K. Gleason, Lexington, MA (US); Daniel D. Burkey, Cambridge, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Massachusetts Institute of Technology, Cambridge, MA

(21) Appl. No.: 10/689,820

(22) Filed: Oct. 21, 2003

Related U.S. Application Data
(60) Provisional application No. 60/419,904, filed on Oct. 21, 2002.

(51) Int. Cl. H05H 1/24; B32B 5/22

(52) U.S. Cl. 428/447; 427/578; 427/255.6; 428/304.4

(57) ABSTRACT

Methods are disclosed for fabricating organosilicate glass (OSG) films that have both a low dielectric constant and superior mechanical strength are disclosed. Cyclic siloxane OSG precursors, such as 1,3,5-trivinyl-1,3,5-trimethylcyclotrisiloxane (V₃D₃), are used in conjunction with a mild oxidant to partially oxidize the cyclic structures leading to the formation of silanol groups. The silanol groups can be subsequently condensed to form a porous OSG film.

### PRIORITY

The present invention claims priority to U.S. Provisional Application No. 60/419,904 filed Oct. 21, 2002.

### BACKGROUND OF THE INVENTION

The technical field of the invention is chemical vapor deposition of materials and, in particular, the formation of thin, low dielectric constant, organosilicate films for use in electronic devices and other applications.

In the attempt to increase processor speeds and to make more powerful microelectronic devices, semiconductor manufacturers seek to reduce the size of microchips. However, as chip sizes decrease, their circuitry gets closer together and the operating frequencies increase, which dramatically amplifies the problems of electrical interference between circuit elements, known as cross-talk. Additionally, as transistors shrink and the total amount of interconnect circuitry continues to increase, delays in the wiring become more important to circuit performance. Intermetal dielectric materials, which provide insulation between circuits, also affect the capacitance of the circuit and contribute to interconnect delays. Thus, improved dielectric materials with lower K values are desired to reduce the noise, preserve the signal, conserve power, and reduce the interconnect delay (ICD) so that microelectronics can continue to become both faster and smaller.

As semiconductor device dimensions continue to shrink, the search for alternative dielectric materials becomes more crucial. Dielectric materials, which are often included in production schemes with mechanically rigorous integration steps, such as chemical-mechanical polishing (CMP), should have excellent thermal stability and mechanical properties without compromising their insulating barrier properties. Current semiconductor processes rely heavily on the use of silicon dioxide (SiO₂) as the interlevel dielectric material, which has a dielectric constant of approximately 4.0. Few materials are currently known that have both low dielectric constants and are compatible with semiconductor manufacturing requirements, such as thermal stability of at least 400° C. Polytetrafluoroethylene (PTFE), for example, has a low dielectric constant, but is not thermally stable above 300-350° C., which restricts its use in integrated circuits. The industry has only recently begun explore alternative dielectrics.

Organosilicate glass (OSG) materials have been used in the production of low dielectric constant materials as an alternative to silicon dioxide. OSG materials are based on the structure of silicon dioxide, with the exception that a certain fraction of the silicon-oxygen bonds have been replaced with silicon-organic bonds, often in the form of alkyl or aryl substituents, such as methyl or phenyl groups. This substitution is generally believed to disrupt the structure of the SiO₂ matrix and lead to a ‘loosening’ of the lattice, resulting in an increase in free volume within the structure. The decreased density and increased free space tend to lower the dielectric constant. Additionally, the organic groups generally have a lower polarizability than the structures they replace. Since the dielectric constant is directly tied to the polarizability of the material in question, this reduction in polarizability results in a reduction in dielectric constant for OSG materials. Depending on the exact chemical composition and deposition techniques, OSG materials can have k-values ranging between 2.6 and 3.5, which is a significant improvement over traditional silicon dioxide. In addition, OSG materials have shown good thermal stability up to 400° C., which is a crucial integration requirement in semiconductor processing.

Unfortunately, many of the critical material properties of interest for OSG thin films can be at least one order of magnitude lower than those for SiO₂, which historically has been the material of choice for dielectric layers. Dense oxides such as SiO₂ typically have hardness values around 10 GPa and elastic moduli of approximately 70 GPa. In contrast, OSG materials typically have hardness values and elastic moduli that are about an order of magnitude lower than SiO₂. This disparity in mechanical properties between conventional SiO₂ and OSG materials has been a concern from the standpoint of integration of OSG materials into a commercially viable device production methodology.

Moreover, most current schemes for creating porous OSG insulating films require the use of spin-on materials. Spin-on deposition involves delivery of an organosilicate material to a substrate in a liquid solution. The substrate (e.g., a wafer) is coated with the solution and rapidly spins to uniformly distribute the material on the surface. A low temperature bake completes the solidification.

Very low dielectric films can be obtained with OSG by modifying the spin-on process to employ biphasic materials consisting of a bulk matrix phase (e.g., an organosilicon material), which provides structural rigidity to the film, and a porogen, or pore forming material. The porogen is generally thermally degradable and removed after spin casting via an annealing step. However, the mechanical properties of such ultra-porous OSG films are often unsatisfactory.

The use of a spin-on process to fabricate thin OSG films has numerous disadvantages, including incompatibility with the other vacuum-based processes used in semiconductor fabrication, single wafer processing requirements, environmentally dangerous reagents, and production of large amounts of solvent/material waste. In addition, studies have shown that low dielectric materials that are formed using CVD are mechanically more robust and produce better results when used in chemical mechanical polishing (CMP) and flip chip bonding.

Hence, there exists a need for better methods of producing low dielectric materials with robust mechanical properties. Techniques that would permit deposition of porous OSG films by CVD methods, rather than wet deposition, would also satisfy a long felt need in the art.

### SUMMARY OF THE INVENTION

Methods are disclosed for fabricating organosilicate glass (OSG) films that have both a low dielectric constant and superior mechanical strength are disclosed. Cyclic siloxane OSG precursors, such as 1,3,5-trivinyl-1,3,5-trimethylcyclotrisiloxane (V₃D₃), are used in conjunction with a mild oxidant to partially oxidize the cyclic structures leading to the formation of silanol groups. The silanol groups can be subsequently condensed to form a porous OSG film.

In one aspect of the invention, a method is disclosed for the pulsed-plasma chemical vapor deposition of cyclic siloxane precursors and a mild oxidant followed by a subsequent condensing step to produce porous OSG films with improved mechanical properties. A mild oxidant is used in the reaction mixture, leading to the formation of silanol (Si—OH) groups that can be condensed to form a rigid matrix in a post-processing step. The mild oxidant can be an oxidant, or oxidizing species, that avoids the formation of a pure oxide species, such as SiO₂. In other words, the mild oxidant does not result in the complete and total oxidation of the organosilicon monomer species to silicon dioxide, which is not intended to be produced. Examples of mild oxidants that can be employed in accordance with the invention include water, primary alcohols, peroxides, N₂O, or other suitable oxidizing species. In a preferred embodiment, water is used as the mild oxidant. In accordance with the invention, subsequent condensing, i.e., annealing, of the films results in condensation of proximal Si—OH groups, further generating an Si—O—Si network and strengthening the film.

In one embodiment, cyclic alkyl substituted siloxane precursors can be used. Non-limiting examples of cyclic alkyl substituted siloxane precursors include 1,3,5-trivinyl-1,3,5-trimethylcyclotrisiloxane (V₃D₃), 1,3,5,7-tetramethylcyclotrisiloxane (H₄D₄), 1,1,3,3,5,5-hexamethylcyclotrisiloxane, 1,3,5-triethyl-1,3,5-trimethylcyclotrisiloxane, and vinylalkylsiloxanes (Chemical structures are shown in Scheme 1.) In a preferred embodiment, 1,3,5-trimethyl-1,3,5-trivinylcyclotrisiloxane (V₃D₃) is used as the organosilicon (OSG) monomer species. Other examples of monomers that can be employed in accordance with the invention include the class of compounds known as vinylalkylsilanes (SiRₓVi₄₋ₓ, where R=alkyl and Vi=Vinyl), vinylalkylsiloxanes (SiₓOₓ₋₁R_{y}Vi_{z}), or other silicon species with at least one silicon-vinyl bond.

In another aspect of the invention, the properties, such as —OH content, hardness, and thermal stability, of the resultant film can be varied by adjusting the plasma duty cycle and/or power density. The plasma in the PECVD reactor can be in pulsed mode or continuous mode. The RF power density can be set between about 0.07 W/cm² and about 2.6 W/cm². The peak power can be set to between about 200 W and about 500 W. The duty cycle can be selected such that the percentage of time that peak power is applied is between about 1% and about 50%. FTIR analysis of experimental results showed increasing OH content with increasing plasma duty cycle. Nano-indentation results confirmed increasing hardness with duty cycle, with the 10/40 annealed sample having a hardness value of 0.527 GPa. These results can be explained within the context of the Continuous Random Network theory and percolation of rigidity arguments. Thermal stability was excellent, with a best-case thickness retention of 99.25% after a two hour anneal at 400° C. under N₂.

In one aspect, the invention provides a method for the fabrication of thin films with low dielectric constants. The dielectric constants for the annealed films can range from about 4 to about 1. The dielectric constant for the annealed film is preferably less than about 3, more preferably less than about 2.9, and most preferably less than about 2.6. The dielectric constant of the films can be designed based upon its desired use.

In another aspect, the invention provides a method for the fabrication of porous dielectric material through the use of alkyl substituted siloxane precursors and degradable porogens. The moderate power involved is amenable to inclusion of a porogen species, opening the possibility of using this methodology to generate an all-CVD porous thin film with adequate mechanical properties. The porous material can have a dielectric constant from about 4 to about 1, preferably from about 3 to about 1, and most preferably from about 2 to about 1. In a preferred embodiment, V₃D₃ can be used as the precursor and a mild oxidant can be used to produce thin films with significant OH content. Coupled with the promising electrical and thermal properties, the V₃D₃/H₂O system is especially appealing when extended to include co-deposition with a thermally sensitive porogen precursor for the creation of a CVD porous thin film.

The porosity of the OSG films can be increased through the incorporation of a porogen that is ultimately removed through an annealing step. In one embodiment, poly(alpha-methylstyrene) (PaMS) can be used as a potential sacrificial material or porogen in the formation of porous thin films. A porous thin film can be created using a suitable porogen material with thermal lability, low decomposition temperature, and minimal residue left behind. A method is disclosed for the synthesis of poly(alpha-methylstyrene) (PaMS) using plasma-enhanced chemical vapor deposition (PECVD). The resultant PECVD PaMS is chemically and spectroscopically similar to commercially available PaMS polymerized by conventional means. PaMS is of interest due to its low decomposition temperature and the fact that its primary decomposition pathway is a reversion to monomer. The porogen and the OSG precursor can be deposited simultaneously or sequentially.

### BRIEF DESCRIPTION OF THE FIGURES

FIG. 1 is a graph of fourier transform infrared spectroscopy (FTIR) Spectra of films deposited from V₃D₃/H₂O at three different duty cycles;

FIG. 2A depicts the FTIR detail of the Si—(CH₃)ₓ stretching region from 1240 cm⁻¹ to 1300 cm⁻¹ for V₃D₃/H₂O films as deposited;

FIG. 2B depicts the FTIR detail of the Si—(CH₃)ₓ stretching region from 1240 cm⁻¹ to 1300 cm⁻¹ for annealed V₃D₃/H₂O films;

FIG. 3A depicts FTIR spectra of the Oₓ—Si—(CH₃)_{y} stretching region for a 10-390 V3D3/H₂O film as-deposited and post-anneal;

FIG. 3B depicts the shift from ‘D’ to ‘T’ functionality in the FTIR spectra of the Oₓ—Si—(CH₃)_{y} stretching region for a 10-390 FTIR V3D3/Argon film as deposited and post anneal;

FIG. 4 is a plot of displacement into surface versus hardness for V₃D₃+H₂O films with different duty cycles;

FIG. 5 is a plot of displacement into Surface versus elastic modulus for V₃D₃+H₂O films at different duty cycles;

FIG. 6A is an FTIR spectrum of low molecular weight (LMW) PaMS standard,

FIG. 6B is an FTIR spectrum of 10/90 pulsed plasma-enhanced CVD (PPECVD) sample;

FIG. 6C is an FTIR spectrum of 40 W continuous wave plasma-enhanced CVD (CW PECVD) sample;

FIG. 6D is an FTIR spectrum of 10/10 PPECVD sample;

FIG. 6E is an FTIR spectrum of 200 W CW PECVD sample;

FIG. 7A is the 1650 cm⁻¹ to 2000 cm⁻¹ region of an FTIR spectrum showing the aryl ring overtone signature of LMW PaMS standard;

FIG. 7B is the 1650 cm⁻¹ to 2000 cm⁻¹ region of an FTIR spectrum showing the aryl ring overtone signature of the 10/90 PPECVD sample;

FIG. 8A is an FTIR spectra of LMW PaMS standard;

FIG. 8B is an FTIR spectra of 10/90 PPECVD sample;

FIG. 8C is an FTIR spectra of 40 W CW PECVD sample;

FIG. 8D is an FTIR spectra of 10/10 PPECVD sample;

FIG. 8E is an FTIR spectra of 200 W CW PECVD sample;

FIG. 9A is a ¹³C solid-state CP-MAS NMR spectra of LMW standard PaMS;

FIG. 9B is a ¹³C solid-state CP-MAS NMR spectra of high molecular weight (HMW) standard PaMS;

FIG. 9C is a ¹³C solid-state CP-MAS NMR spectra of pulsed-plasma (10/90) deposited PaMS;

FIG. 10A depicts the detail of aliphatic carbon chemical shift region for LMW standard PaMS;

FIG. 10B depicts the detail of aliphatic carbon chemical shift region for HMW standard PaMS;

FIG. 10C depicts the detail of aliphatic carbon chemical shift region for pulsed-plasma (10/90) deposited PaMS;

FIG. 11A is a thermal stability trace for 10/90 PPECVD aMS sample;

FIG. 11B is a thermal stability trace for 10/10 PPECVD aMS sample; and

FIG. 12 is a graph of the pore size distribution for two PPECVD V₃D₃/H₂O films demonstrating the fractional porosity occupied by voids of a particular spherical pore diameter.

### DETAILED DESCRIPTION OF THE INVENTION

The invention provides methods for the production of a porous thin film with an all-CVD process, rather than the conventional spin-on processes. This CVD processing enables seamless compatibility with existing toolsets, lower environmental impact, and less solvent/material waste than with conventional spin-on processes. More specifically, the invention provides precursors and CVD process conditions that overcome the seemingly incompatible deposition requirements of matrix and porogen species to be employed for producing a porous film.

The low dielectric constant films of the present invention are produced using a plasma-enhanced CVD (PECVD) system. Within the PECVD chamber, the cyclic siloxane precursors are delivered onto the substrate along with a mild oxidant. The mild oxidant can be delivered either at the same time or following the deposition of the cyclic siloxane precursors. The term “substrate” as used herein refers to a material having a melting temperature that is at least about 300° C., preferably above 350° C., and more preferably above 400° C., and most preferably above 450° C. Suitable substrates comprise, but are not limited to, silicon, silicon dioxide, silicon-germanium, glass, silicon nitride, ceramics, aluminum, copper, and gallium arsenide. The mild oxidant partially oxidizes the cyclic siloxanes, thereby converting the cyclic structures into silanol groups. The use of the mild oxidant allows control of the organic content and the steric effect of the organic groups in the OSG films. Following deposition, the silanol groups are condensed to form an OSG film. This condensing step, i.e., annealing, allows the silanol groups to react or polymerize on the substrate, thereby forming the OSG film.

This invention decouples the creation of a mechanically robust matrix from the deposition step. The creation of the matrix from methyl substituted siloxane precursors is part of the post-processing step. A mild oxidant, such as water, is used as an oxidizing species in the reaction mixture, leading to the formation of silanol (Si—OH) groups that can be condensed to form a rigid matrix in a post-processing step. This method translates the deposition space to a regime where porogen deposition is favorable and enhances the mechanical properties of the matrix.

I. Pulsed PECVD

In a plasma-enhanced CVD (PECVD) system, a precursor gas is fed into a reaction chamber at low pressure where it is exposed to a large electric field. This excitation results in fragmentation of the precursor and generates plasma, consisting of electrons, ions, and reactive neutral species. These reactive species recombine in various forms to create a thin film of material on the target substrate. In a continuous-wave (CW) PECVD system, the electric field is applied for the entire duration of the reaction. Depending on the peak power applied, the typical result is significant fragmentation of the precursor molecule. As the peak power is increased, the chemical composition and structure of the resulting thin film bears less and less resemblance to the starting material and is often highly branched or crosslinked due to the high degree of fragmentation. This branching can be advantageous if the ultimate goal is a highly crosslinked structure. One of the primary disadvantages of the CW PECVD technique is that the growing thin film is exposed to the plasma throughout the deposition process. This can lead to fragmentation and branching in the thin film itself, as well as the creation of defects and dangling bonds-non-terminated radical sites in the film. These dangling bonds and defects can react with atmospheric gases or other species upon exposure, resulting in undesired side reactions or chemical modifications, such as oxidation.

Another often-undesirable feature of CW PECVD depositions is the formation of significant quantities of powdered material in competition with or opposed to thin film growth. Powder formation has been attributed to rapid gas-phase polymerization of the precursor molecules. These gas-phase materials are often charged species, and as a result, they remain suspended in the plasma sheath, growing to macroscopic size until gravitational forces win out and the material precipitates out of the gas phase as a fine powder. Moving to a pulsed-plasma deposition regime can mitigate some of these disadvantages.

In pulsed-plasma enhanced CVD (PPECVD) the electric field is instead turned on and off at a discrete frequency, which results in the plasma only being present during a set fraction of the reaction time. The primary variable used to control the plasma timing is the duty cycle, which is defined as the ratio of the plasma on-time to the total pulse cycle time. Pulse timing is usually measured in milliseconds; for example, a 10-90 pulse timing would be 10 milliseconds on followed by 90 milliseconds off. This represents a duty cycle of 10%. It should be noted that it is possible to have the same duty cycle for a number of different pulse timings: a 10-90 pulse cycle timing and a 50-450 pulse cycle timing both have a duty cycle of 10% even though the actual on and off periods are different. The pulsed nature of the plasma can provide a number of advantages over a continuously applied plasma. First, since the plasma is only present for a short period of time, the growing film is exposed to significantly less UV radiation and ion bombardment from the plasma. The reduced exposure lessens the formation of defects and dangling bonds in the growing film, which in turn reduces the probability of undesired side reactions and chemical modifications upon exposure. Pulsing the plasma also reduces the occurrence of gas-phase polymerization, since in the plasma off-time, the gas-phase reactants are not being stimulated, and additionally, the absence of the electric field results in no force to keep charged oligomeric products suspended in the gas phase. In short, material is never given the opportunity to grow to macroscopic size in the gas phase in the pulsed-plasma regime.

One final advantage of the pulsed-plasma technique is the finer control over reactive species that is possible. Pulsing the plasma results in only a small amount of RF energy being delivered to the precursor species at any one time. This means that the precursor molecule is not necessarily fragmented completely during the deposition step and also opens the possibility for selective activation. The ability to exert some control over reaction pathways becomes very important when considering the use of the PPECVD technique for deposition of polymeric materials that need to retain desired functionality, or using the technique to build a desired chemical functionality into a thin film.

II. Organosilicate Glass (OSG) Monomers

In one aspect of the invention, cyclic siloxane precursors are employed in the chemical vapor deposition (CVD) process to produce OSG's. Siloxanes are usually derived from partly substituted silicon chlorides, such as dichlorodimethylsilane, SiCl₂(CH₃)₂, since the replacement of the chlorines with oxygen links leads directly to cyclic and linear polymers (Noll, W. 1968 Chemistry and Technology of Silicones (Academic Press)). Methyl cyclosiloxanes can be used as a starting material, precursor, for manufacture of linear siloxane polymers by ring-opening polymerization (Kendrick, T. C. et al. 1989 Siloxane polymers & copolymers, in The Chemistry of Organic Silicon Compounds Eds S Patai & Z Rappoport (Wiley Interscience) p. 1289). Cyclosiloxanes can be functionalized by substituting different side groups, which can vary the properties of the resulting polymers.

In one embodiment, cyclic alkyl substituted siloxane precursors can be used. Non-limiting examples of cyclic alkyl substituted siloxane precursors include 1,3,5-trivinyl-1,3,5-trimethylcyclotrisiloxane (V₃D₃), 1,3,5,7-tetramethylcyclotrisiloxane (H₄D₄), 1,1,3,3,5,5-hexamethylcyclotrisiloxane, 1,3,5-triethyl-1,3,5-trimethylcyclotrisiloxane, and vinylalkylsiloxanes (Chemical structures are shown in Scheme 1.) In a preferred embodiment, 1,3,5-trimethyl-1,3,5-trivinylcyclotrisiloxane (V₃D₃) is used as the organosilicon (OSG) monomer species. The monomer, 1,3,5-trimethyl-1,3,5-trivinylcyclotrisiloxane (Silar Laboratories, 98%) can be used without further purification. Other examples of monomers that can be employed in accordance with the invention include the class of compounds known as vinylalkylsilanes (SiRₓVi₄₋ₓ, where R=alkyl and Vi=Vinyl), vinylalkylsiloxanes (SiₓOₓ₋₁R_{y}Vi_{z}), or other silicon species with at least one silicon-vinyl bond.

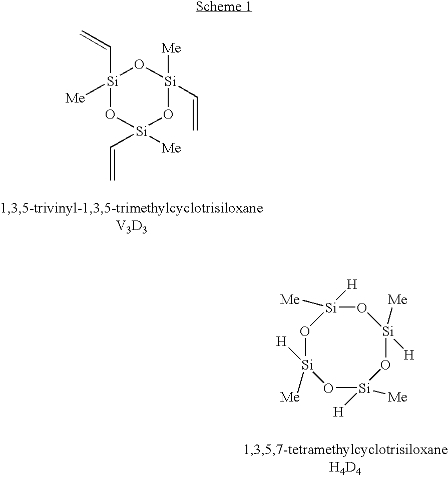

The monomers are preferably volatilized and delivered to the reaction chamber through the powered showerhead assembly via a mass flow controller. The OSG monomers are fed at a flow rate of between about 1 sccm and about 100 sccm, or preferably at a flow rate of between about 1 sccm and about 20 sccm.. A flow rate of about 2 sccm was found to be a suitable for many applications. Certain combinations of flow rate and power can lead to powder formation versus thin film deposition, which is to be avoided.

III. Oxidants

In another aspect of the invention, a mild oxidant is used to oxidize the cyclic siloxane precursors into silanol groups. The inclusion of an oxidant, such as water, as a reagent enables the formation of Si—OH moieties in the as-deposited films. These Si—OH groups can then undergo a condensation reaction during a subsequent annealing step in a manner similar to the network-forming reactions observed in spin-on OSG materials. The invention thereby provides a discovery that contrary to conventional wisdom, a mild oxidant, such as water, can also be employed in a plasma OSG system for the express purpose of inducing condensation chemistry in a subsequent annealing step. This reaction leads to the creation of additional Si—O—Si linkages which are responsible for the increased quantity of “T” groups and additional film crosslinking. “M,” “D,” “T,” and “Q” are used to describe siloxane building blocks as depicted in Scheme 2. Scheme 3 depicts the condensation chemistry in an organosilicon network between two proximal silanol moieties. According to the invention, following mild oxidation, “T” and “Q” building blocks are preferentially obtained. These building blocks can then be used to form films with low dielectric constants that form network structures and therefore become mechanically rigid by limiting the degrees of freedom.

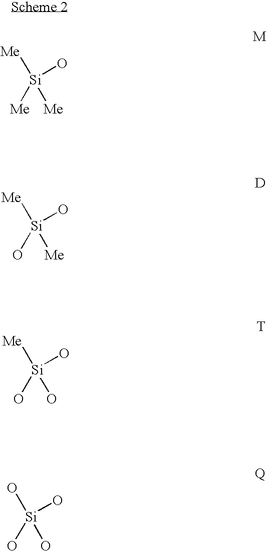

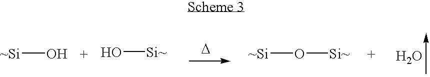

In accordance with the invention, a mild oxidant is introduced with the monomer to the CVD deposition region, e.g., through the showerhead, through a side port in the main reactor assembly, or through another introduction site. A “mild oxidant” as used herein refers to an oxidant, or oxidizing species, that avoids the formation of a pure oxide species, such as SiO₂. In other words, the mild oxidant does not result in the complete and total oxidation of the organosilicon monomer species to silicon dioxide, which is not intended to be produced. The mild oxidant has the ability to access deposition spaces not previously accessible with the methyl substituted siloxane precursors making this method an attractive one for enhancing the mechanical properties of OSG films deposited at lower powers in the absence of a strong oxidant. Examples of mild oxidants that can be employed in accordance with the invention include water, primary alcohols, peroxides, N₂O, or other suitable oxidizing species. In a preferred embodiment, the mild oxidant is deionized water. The oxidant can be introduced with a flow rates of between about 5 sccm and about 400 sccm, or preferably between about 5 sccm and about 30 sccm. A flow rate of about 20 sccm is usually suitable for many applications. The monomer to oxidant molar ratio can range from 1:1 to 1:100 depending on the desired application of the resultant film. A monomer is defined herein to be a single molecule of precursor gas, such as a cyclic siloxane molecule of V₃D₃. Preferred monomer to oxidant ratios range from 1:5 to 1:20. Examples of monomer to oxidant ratios of 1:5, 1:10, and 1:20 can be found in the Examples section.

It is found in accordance with the invention that powder formation, rather than thin film growth, can result when certain harsh oxidants, such as oxygen, are employed instead of a milder oxidant, such as water. Specifically, a harsh oxidant, as defined herein, may form a pure oxide species from the monomer, resulting in a film that does not include organic content because of this total oxidation of the organosilicon species. Thus, the use of a mild oxidant such as water, which in accordance with the invention does not result in total oxidation of the organosilicon species, is preferred. This preference is not only from the standpoint of increasing the hardness of the porous films, but also for enabling access to a deposition space previously inaccessible for thin film growth with this precursor.

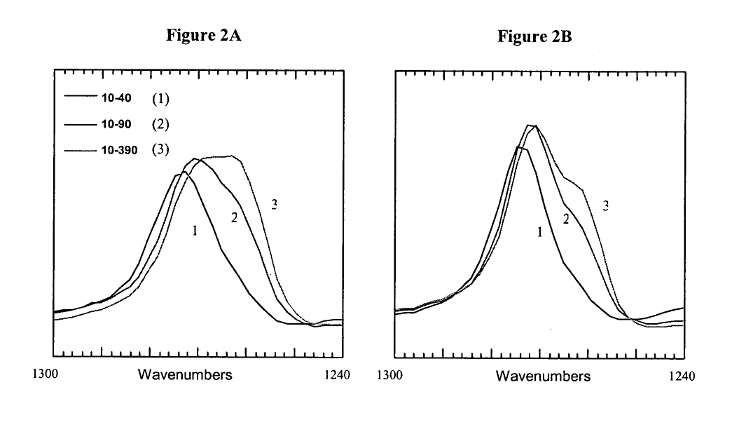

The invention provides processes for producing thin films of very low dielectric constant by way of —OH inclusion. The degree of —OH inclusion can be assessed either directly by FTIR or indirectly via optical and electrical measurements (See Examples). In one embodiment, the degree of incorporation of these groups can be adjusted by varying the pulsed plasma duty cycle. The degree of incorporation of these groups increases with increasing pulsed plasma duty cycle, FIG. 2.

IV. Condensation

In one embodiment of the invention, the film can be heated to condense the silanol groups and thereby remove the —OH groups. The film can be heated to a temperature less than 425° C. for a duration between about 15 minutes to about 2 hours under inert atmosphere, under a nitrogen atmosphere or under vacuum conditions. For example, annealing of the film at about 400° C. in a N₂ atmosphere for about two hours successfully removes the —OH groups, as confirmed by FTIR (See Example II). FTIR analysis also confirms that condensation chemistry between proximal Si—OH groups is occurring during the annealing step, given that the V₃D₃/H₂O films exhibit structural changes, such as enhanced Si—O—Si bonding and a shift from “D” to “T” type bonding environments, which are consistent with condensation chemistry and network forming reactions. Mechanical testing of experimental films produced in accordance with the invention revealed that both modulus and hardness were increased with increasing pulsed plasma duty cycle, consistent with a higher degree of oxidation in the films (see Example III).

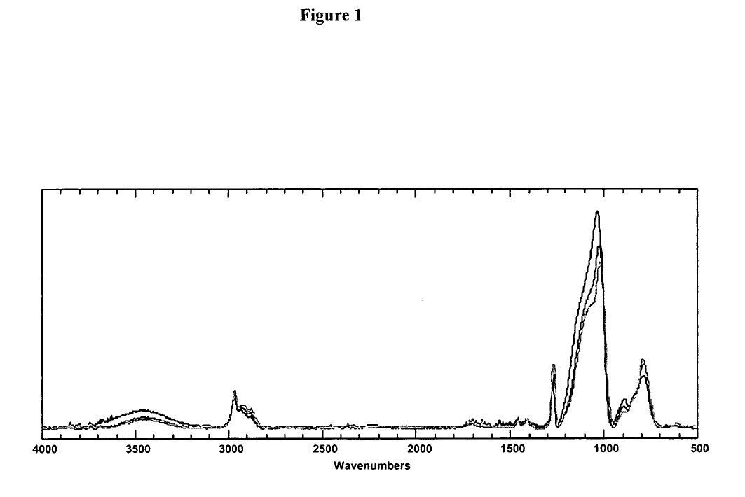

Incorporation of the H₂O into the film structure is readily apparent by the broad —OH stretching band between 3200 cm⁻¹ and 3700 cm⁻¹. The Si—O stretch from the Si—O—H group also gives rise to a strong band observed between 920 cm⁻¹ and 830 cm⁻¹. Both bands increase in intensity with increasing pulsed plasma duty cycle, indicating a greater degree of —OH incorporation at higher applied powers (See FIG. 1). This increase in Si—O bonding is contrasted with a decrease in the intensity of bands associated with Si—C bonding in the 870 cm⁻¹ to 750 cm⁻¹ region, indicating that the OH groups are indeed bonding to the silicon atoms at the expense of some organic content. The Si—O—Si backbone absorbance appears between 1000 cm⁻¹ and 1200 cm⁻¹.

The peak centered at approximately 1025 cm⁻¹ increases in intensity with the increase in pulsed plasma duty cycle and is associated with longer chain siloxanes or the formation of a networked structure. The peak centered at approximately 1125 cm⁻¹ appears as a shoulder on the main peak and also increases in intensity with increasing plasma duty cycle. This band is often assigned as the ‘cage’ structure similar to a silsesquioxane. An increase in these bands with increase in plasma duty cycle is consistent with the increase in other Si—O specific bonding. Further increase in the intensity of these bands with annealing is evidence of Si—O—Si network and ‘cage’ formation during the annealing process.

The Si—(CH₃)ₓ symmetric stretching band occurs in the 1240 cm⁻¹ to 1300 cm⁻¹ region of the FTIR spectrum (See FIG. 2). This band can vary in position based upon the degree of oxidation of the Si atom, with increasing oxidation shifting the band to higher wavenumbers. The three most basic possibilities for the configuration are designated as ‘M’, ‘D’, and ‘T’, reflecting either mono-, di-, or tri-substitution of the silicon atom by oxygen. These configurations are included in Table 1, along with their typical band position in the FTIR spectrum. In a plasma-deposited film, a mixture of these different configurations is possible. FIG. 2A shows the as-deposited spectra for the three V₃D₃/H₂O films. With increasing power, this band is shifted from a ‘D’ rich structure to a ‘T’ rich one, indicating the inclusion of more oxygen into the film and potential crosslinking. FIG. 2B shows the spectra for the same three films after annealing. The peaks in FIG. 2B have been shifted to higher wavenumbers with both increased duty cycle and annealing indicating a shift from ‘D’ to ‘T’ functionality and greater cross-linking. This significant shift from the ‘D’ rich structure to a more ‘T’-like structure is especially distinct in the lowest duty cycle (10-390) sample. Together with the disappearance of the —OH bands in the high wavenumber region, this shift can be attributed to condensation chemistry occurring between proximal Si—OH groups as outlined above in Scheme I. This reaction leads to the creation of additional Si—O—Si linkages which are responsible for the increased quantity of ‘T’ groups and additional film crosslinking. t,0170

In another aspect of the invention, moderate plasma power conditions are used. Deposition under moderate power conditions, rather than conventional high power conditions, allows for the concurrent deposition of matrix and porogen species for later removal of the porogen species and formation of a porous thin film.

V. Average Connectivity Number

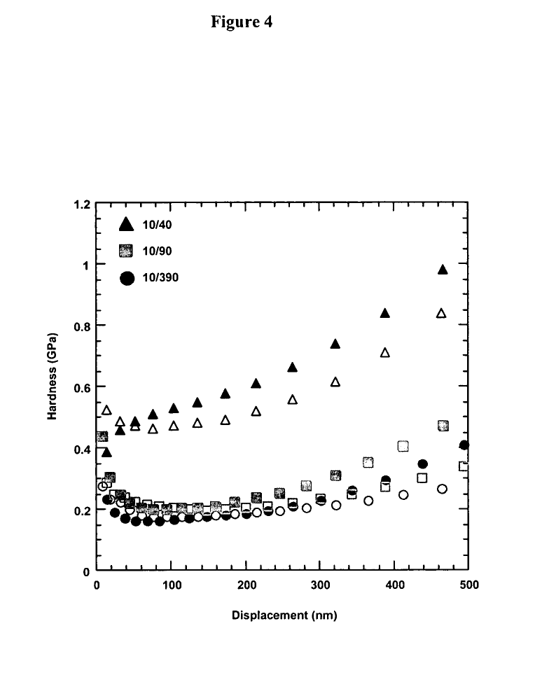

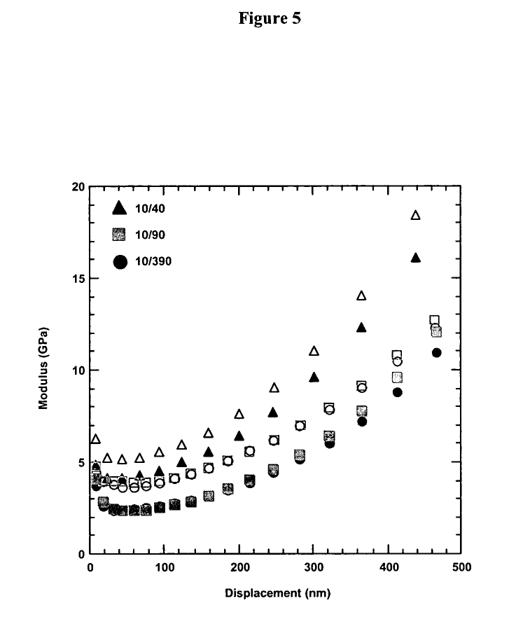

In another aspect, mechanical integrity can be enhanced by depositing a film with a higher average connectivity. As the average connectivity number moved towards the percolation threshold, the mechanical properties improve. Hence, depositing a film with an average connectivity number above the threshold enhances mechanical integrity. This phenomenon explains the similar mechanical performance of the 10/90 and 10/390 samples, since both had similar connectivity numbers and were below the percolation threshold (See FIGS. 4 and 5). The 10-40 V₃D₃/H₂O annealed film performed best, having a high hardness value (averaged over the sample space) of 0.527 GPa and an average connectivity number of 2.39. For comparison, the annealed 10-390 V₃D₃/Argon system had a connectivity number of 2.19 and an average hardness 0.239 GPa, which is just 45% of the 10-40 film's value.

In one aspect of the invention, hardness and modulus can be predicted within the framework of the known ‘Continuous Random Network’ (CRN) and percolation of rigidity theories. The percolation of rigidity defines a compositional point in a network where the system transitions from an underconstrained (non-rigid) state to an overconstrained (rigid) one. Systems above the percolation threshold would thus be expected to have superior mechanical properties as compared to those below the threshold, owing to the increased structural constraints. The key parameter in this analysis is the average connectivity number, <r>, which is the average number of bonds per network forming atom. Network-forming atoms have two or more bonds to other network forming atoms, and atoms having only one bond, such as hydrogen, which do not contribute to the network are not counted in the analysis. It is known that the percolation of rigidity occurs at an average connectivity number of 2.4 for solids in which all atoms are able to form two or more bonds.

To determine the average connectivity number of porous films produced in accordance with the invention, it is necessary to determine the structural composition of the film. The Si—CHₓ region of the FTIR spectrum allows determination of the relative quantities of Si, O, and C bonding in the film, and as such, can be useful for a basic structural analysis. Spectral curve fitting of the Si—CHₓ band between 1240 cm⁻¹ and 1300 cm⁻¹ can resolve the relative contributions from the different structures (‘D’ groups vs. ‘T’ groups, etc.). Table II summarizes this curve fitting for the annealed V₃D₃/H₂O system. Note that the percentage of ‘T’ groups relative to ‘D’ groups increases with increasing duty cycle, which is consistent with increased oxygen content with increasing power.

TABLE II
FTIR Composition Fit Percentages and Connectivity Numbers

| | | | Avg. |
|---|---|---|---|
| | | | connectivity # |
| Sample | % ‘T’ | % ‘D’ | <r> |
| 10-40 Annealed | 96.5 | 3.5 | 2.39 |
| 10-90 Annealed | 86.4 | 13.6 | 2.35 |
| 10-390 Annealed | 81.5 | 18.5 | 2.33 |
| Silica | — | — | 2.67 |

As an example, the average connectivity number for the ‘T’ group is 2.4. Silicon and oxygen are the network-forming species, while carbon, because it does not bond to structures outside the local ‘T’ structure, is considered non-network-forming. The silicon atom has three network-forming bonds (each to oxygen), and each oxygen forms two network bonds (one to the local silicon, and another to the silicon in the adjacent network node). To avoid double-counting, each oxygen is counted as one-half an atom in the analysis. The average connectivity number is thus the sum of the network-forming bonds (1_{Si}×3_{bonds}+1.5_{O}×2_{bonds}) divided by the total number of atoms (1_{Si}+1.5_{O}). This analysis gives (6/2.5)=2.4, as indicated previously. Performing a similar analysis for the ‘D’ group gives a connectivity number of 2, as would be expected for a linear structure without branch points. For comparison, the connectivity number for SiO₂, which is a fully networked structure, is 2.67. In general, for an OSG material with the structural formula SiₓO_{y}(CH₃)₂, where all carbon atoms are assumed to be in the form of methyl groups bound to silicon, the average connectivity number can be given by equation 1:

$$⟨ r ⟩ = \frac{[ ( 4 x - z ) + 2 y ]}{( x + y )} \qquad ( 1 )$$

The relative fractions x, y, and z can be determined via appropriate film characterization techniques, such as XPS or FTIR, as in the present case.

The average connectivity number for the entire sample is then the sum of the weighted contributions from each of the major network-forming species. Multiplying the connectivity number of each group type by its relative abundance as determined by FTIR analysis gives the average connectivity number for the annealed V₃D₃/H₂O samples. Results are again summarized in Table II. The 10/40 annealed sample was found to have an <r> value of approximately 2.39, which is extremely close to the percolation threshold value of 2.4. The 10/90 and 10/390 samples were found to have <r> values of 2.35 and 2.33, respectively. These values correlate well with the observed trends in hardness and modulus, confirming that as the connectivity number approaches the percolation of rigidity point, there is a marked improvement in mechanical properties. It is understood in accordance with the invention that for various CVD deposition parameters and selected chemistries, thin porous films in accordance with the invention and having <r> greater than 2.4 can be achieved, thereby provided further enhancement in mechanical properties over the experimental results described above.

Thermal properties of all of the experimentally prepared films were excellent, with >98% thickness retention for all samples, showing that no bulk decomposition or shrinkage of the matrix occurs, a characteristic that is preferable for a matrix/porogen-based process like that of the invention. Optical properties of experimentally prepared films, as measured via spectroscopic ellipsometry, indicated that the annealed V₃D₃/H₂O samples were less dense than their as-deposited counterparts. As-deposited indices of refraction dropped from an average of approximately 1.47 to an average value of approximately 1.43 after annealing. This is indicative of an increase in free volume and reduction in density that may occurring due to the structural rearrangement and Si—O—Si network forming. This same trend was not observed in the V₃D₃/Argon sample, where the index of refraction only decreased to 1.454 from an as-deposited value of 1.475. This is due to the fact that the V₃D₃/Argon system is not undergoing the same structural rearrangements as the V₃D₃/H₂O samples. Post-anneal electrical properties compare favorably with those of known dense OSG materials, with the 10-40 V₃D₃/H₂O sample (best mechanical properties) having a post-anneal k-value of 2.90.

According to the invention, pulsed-plasma chemical vapor deposition of V₃D₃/H₂O and subsequent annealing of the films is discovered in accordance with the invention to produce an improvement in the mechanical properties of porous films as compared to films deposited without a mild oxidant such as water. This fact, combined with the ability to access deposition spaces not previously accessible with the V₃D₃ precursor, make this method an attractive one for enhancing the mechanical properties of OSG films deposited at lower powers in the absence of a strong oxidant. Coupled with the promising electrical and thermal properties, the V₃D₃/H₂O system is especially appealing when extended to include co-deposition with a thermally sensitive porogen precursor for the creation of a CVD porous thin film.

VI. Poly alpha-methylstyrene (PaMS): Using Continuous- and Pulsed-Plasma CVD

Methods are also provided to form thin films deposited from pure alpha-methylstyrene via both continuous- and pulsed-plasma chemical vapor deposition. FTIR and solid-state NMR spectroscopies (See Example VI) were used to demonstrate that the lower power depositions produced plasma polymers with structures virtually identical to that of a traditionally polymerized material. Films deposited at higher powers under both continuous and pulsed conditions showed a marked loss of structural similarity with both the monomer and traditionally polymerized PaMS, and were more cross-linked than their lower power analogs, as evidenced by FTIR spectroscopy. Aging of the polymers at ambient conditions for one month revealed the incorporation of oxygen into the film structure. Samples prepared under pulsed-plasma conditions primarily showed inclusion of hydroxyl (OH) and carbonyl (C═O) groups. Films deposited under CW plasma conditions also showed hydroxyl and carbonyl inclusion, as well as a strong C—O—C band whose formation can be attributed to the higher concentration of radical sites in the CW samples as compared to the pulsed-plasma samples (see Example V). All modes of oxygen incorporation are consistent with literature data on oxidation pathways.

In another aspect of the invention, the properties of the resultant film can be controlled by varying the plasma power and/or deposition mode (continuous or pulsed). For example, the annealing conditions can be kept the same and the plasma power can be varied. As shown in Example VII, samples were also annealed for two hours at 400° C. under nitrogen. Annealing the samples resulted in different degrees of film loss, with the samples deposited at lower powers showing the most promising decomposition results. The low power pulsed-plasma film had 9% film residue remaining post-anneal, and the low power CW film was completely removed, leaving bare silicon. Both of the high power samples retained approximately 40% of their original thickness post-anneal, supporting the FTIR conclusion that films produced at higher powers are significantly more cross-linked. This also demonstrates that tunable properties are possible with the choice of plasma power and deposition mode (continuous or pulsed).

Methods for fabricating thin films deposited from pure alpha-methylstyrene via both continuous- and pulsed-plasma chemical vapor deposition are disclosed. FTIR and solid-state NMR spectroscopies show that the lower power depositions, i.e. less than 150 W or preferentially less than 50 W, produced plasma polymers with structures virtually identical to that of a traditionally polymerized material (See Examples V, VI, and VII). Films deposited at higher powers, i.e., greater than 150 W or preferentially greater than 190 W, under both continuous and pulsed conditions showed a marked loss of structural similarity with both the monomer and traditionally polymerized PaMS, and were more cross-linked than their lower power analogs, as evidenced by FTIR spectroscopy. Aging of the polymers at ambient conditions for one month revealed the incorporation of oxygen into the film structure. Samples prepared under pulsed-plasma conditions primarily have inclusion of hydroxyl (OH) and carbonyl (C═O) groups. Films deposited under CW plasma conditions also have hydroxyl and carbonyl inclusion, as well as a strong C—O—C band whose formation can be attributed to the higher concentration of radical sites in the CW samples as compared to the pulsed-plasma samples. All modes of oxygen incorporation are consistent with literature data on oxidation pathways.

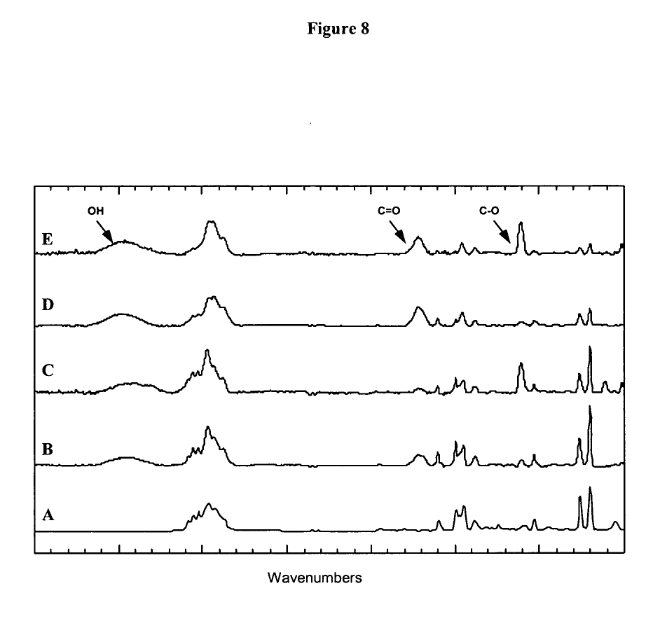

Comparing samples produced under CW versus pulsed conditions, the primary difference is the presence of a strong C—O band at approximately 1100 cm⁻¹ in the CW samples (FIGS. 8C and 8E). This band is present in the pulsed-plasma samples (FIGS. 8B and 8D), but at a significantly reduced intensity. Typically, this band could be assigned to the C—C—O stretching vibration in the C—C—O—H complex, but this does not explain the disproportionate intensity between the CW and pulsed-plasma samples, considering that the O—H intensity is not vastly different between the two sets of spectra. Given that the reaction of an alkyl radical, R•, with molecular oxygen, O₂, results in the formation of a radical RO₂•, we can consider the following mechanism for radical termination in the film:

R•+O₂ RO₂•

R•+RO₂• R—O—O—R

RO₂•+RO₂• R₁R₂C═O+R₁R₂CH—OH+O₂

This accounts for the presence of the carbonyl and hydroxyl species in the film. However, if we also consider the fact that the continuous plasma films should have a higher radical density (R•) due to their deposition conditions, we can also consider the following:

R•+O₂ RO₂•

2 RO₂• 2 RO•+O₂

RO•+R• R—O—R

This would account for the strong apparent presence of C—O bonding in the continuous plasma films without the additional increase in O—H bonding.

The FTIR analysis (See Example V) shows that the input power and type of excitation (continuous or pulsed) have a significant effect on the structure of the final polymer film, with higher power samples showing a marked decrease in retention of monomer structure. Lower power samples show a much better correspondence with the structure of traditionally polymerized materials, with the 10/90 pulsed plasma sample showing the best match to the standard sample. Differences in aging upon exposure to atmosphere were also evident based upon deposition mode.

The incorporation of oxygen into the film structure upon exposure to atmosphere did not appear to have a significant effect on the thermal decomposition of the films. The greatest effect was from plasma power, with the two higher power samples showing a significant film residue after the annealing step. Both of the low power samples (pulsed and continuous) showed desirable decomposition characteristics, with the 10/90 PPECVD sample exhibiting approximately 9% film residue. The 40 W CW sample showed 0% film residue post anneal, and the surface was indistinguishable from bare silicon via ellipsometry. As noted earlier, the low decomposition temperature and minimal film residue post-anneal for the low power samples make them excellent candidates for sacrificial layers or porogens. Additionally, it appears that varying the deposition conditions allows a range of decomposition temperatures to be accessed, which could be a valuable feature in the potential integration into a multicomponent system. It is unclear at this time whether this difference between the low power samples is due to some small structural difference or simply to the discrepancy in original thickness between the samples. Results are summarized in Table 8.

VII. Porogens

The PECVD processes of the present invention can further be employed to deposit a porogen species having characteristics like that of counterpart conventionally produced species, thereby enabling co-deposition of a matrix monomer and a thermally sensitive porogen precursor for the creation of a CVD porous thin film. Specifically, plasma-enhanced chemical vapor deposition from alpha-methylstyrene can be employed as a dry method for synthesizing directly patternable sacrificial materials for generating pores or air dielectric layers. Films deposited at low power excitation (40 W) are found to decompose between 65° C. and 75° C., leave minimal residue following a 400° C. anneal for 2 hours, and have spectroscopic signatures of linear poly(alpha-methylstyrene) (PaMS) as determined by NMR and FTIR. Increased plasma excitation power leads to crosslinking and increased residue after annealing. All experimentally produced films were found to contain hydroxyl and carbonyl groups after exposure to air. Significant C—O—C inclusion was found to occur under continuous plasma excitation but not under pulsed-plasma conditions.

As noted above, plasma-enhanced chemical vapor deposition (PECVD) can enable production of thin films of poly(alpha-methylstyrene) (PaMS) that are chemically and spectroscopically similar to commercially available PaMS polymerized by conventional means. PaMS is of interest due to its low decomposition temperature and the fact that its primary decomposition pathway is a reversion to monomer, as well as its potential use as a photoresist material. PaMS and some of its chlorinated derivatives have been shown to be sensitive to e-beam lithography. Additionally, there has been shown a chlorinated PaMS derivative that is sensitive to optical irradiation at a wavelength of 254 nm. The primary mechanism of decomposition was main chain scission. These characteristics make it a promising candidate for use as a potential air gap material, or porogen, a pore-forming species in a porous thin film. PaMS can be used as a porogen with the methods of this invention to produce films with increased porosity and a decreased dielectric.

In forming ultra-porous OSG films by PECVD, the matrix must be structurally rigid as well as minimally bonded to the porogen species in order to avoid structural collapse of a porous thin film matrix after the removal of the porogen. Typically, it has been understood that the production of a rigid or hard matrix requires the use of high input powers and substantial amounts of oxygen as a cross-linking agent. However, these conditions are highly unfavorable for the successful deposition of the porogen species, which often require specific chemical moieties to be retained in order to preserve their thermally labile quality. High plasma powers and oxygen content will often destroy these moieties and alter chemical functionality. Hence, lower power densities (e.g., less than about 150 W) are typically desirable.

The term “porogen” as used herein refers to a pore forming material that is degradable. The porogen can be thermally degradable such that upon heating to the material's decomposition temperature will decompose and diffuse. The porogen decomposition temperature should be sufficiently high to permit standard film preparation yet below the transition temperature of the surrounding matrix. Porogens should have a decomposition temperature of at least about 200° C., preferably above about 300° C., more preferably above 350° C., and most preferably above 400° C. Alternatively, the porogen can be degraded upon exposure to radiation at an appropriate wavelength or upon treatment in a reactive plasma. The porogen monomer should preferentially react with itself to form a separate domain from the OSG matrix material, resulting in minimal covalent bonding between the matrix and the porogen phases. This facilitates the easy removal of the porogen during the post-processing step. Detailed description of porogen monomer incorporation is in the Examples section.

Porogens are pore forming materials having a lower decomposition temperature than the surrounding matrix, such that upon heating or irradiation the porogens decompose resulting in the formation of pores. Removal of the porogen species can be achieved in a number of ways. Porogen decomposition can efficiently be accomplished, for example, through heating, annealing, irradiation by photons or electrons, volatilization, sublimation, or exposure to a plasma. For example, heating in a nitrogen atmosphere for 2 hours at 400° C. is typically sufficient for many material combinations. Alternatively, porogens that are sensitive to radiation can be exposed to the corresponding wavelength radiation to degrade the polymer. Treatment of film in a reactive plasma can also be employed to selectively remove the porogen species.

Any labile organic polymer can be used as a porogen. The material used for the porogen depends upon the desired product. Polymeric porogens, such as polymethylmethacrylate, polyalphamethylstyrene, and polystyrene, are preferred. Suitable porogens comprise decomposable polymers, including not only linear, branched and crosslinked polymers and copolymers, but also crosslinked polymeric nanoparticles with reactive surface functionality. Preferably, the porogen is a polymer comprised of monomer units selected from the group consisting of styrene, halogenated styrene, hydroxy-substituted styrene, lower alkyl-substituted styrene, acrylic acid, acrylamide, methacrylic acid, methyl acrylate, ethyl acrylate, butyl acrylate, polyacrylate, ethylene oxide, propylene oxide, poly(methyl methacrylate) (PMMA), polystyrene and poly(alpha-methyl styrene) and combinations thereof. Additional polymers that may serve as the porogen herein include, but are not limited to, aliphatic polycarbonates such as poly(propylene carbonate) and poly(ethylene carbonate); polyesters; polysulfones; polylactides; polylactones. The porogen may be a homopolymer, or it may be a copolymer comprised of any of the foregoing monomeric materials, e.g., poly(styrene-co-alpha-methyl styrene), poly(styrene-ethylene oxide), poly(ether-lactones), poly(ester-carbonates), and poly(lactone-lactides). Most preferably, poly(alpha-methylstyrene) (PaMS), poly(methyl methacrylate) (MMA), poly(oxymethylene) (POM), or poly(alkylcarbonates) can be used as the porogen species.

Once produced, the resultant porogens can be used to create an ultra-porous material. For example, the present invention can be used in conjunction with U.S. application Ser. No. 10/624,959 entitled “Porous Material Formation by Chemical Vapor Deposition onto Colloidal Crystal Templates” filed Jul. 22, 2003.

This invention is further illustrated by the following examples, which should not be construed as limiting. The contents of all references, patents and published patent applications cited throughout this application, are incorporated herein by reference.

### EXAMPLES

I. Materials and Methods

A. Materials

1,3,5-trimethyl-1,3,5-trivinylcyclotrisiloxane (V₃D₃) (Silar Laboratories, 98%) was used as the organosilicon (OSG) monomer species without further purification. Water (deionized, reagent grade, Ricca Chemical Company) was employed as the mild oxidant. Alpha-methylstyrene (Aldrich, 99%) was used as the monomer species without further purification. The monomer was volatilized in a metal crucible and delivered to the reaction chamber through the powered showerhead assembly via an MKS 1153A Low Vapor Pressure mass flow controller at a flow rate of approximately 2 sccm. Argon, at a flow rate of approximately 3 sccm, was also fed into the chamber via the showerhead.

B. Production of Porous OSG Films

Production of a porous OSG film in accordance with the invention was carried out in a vacuum chamber similar to those described in U.S. Pat. No. 6,156,435; U.S. Pat. No. 6,153,269; and U.S. Pat. No. 5,888,591. Substrates consisted of 100-mm-diameter silicon wafers. Chamber pressure was controlled by a butterfly valve connected to an MKS model 252-A exhaust valve controller and was maintained at approximately 250 mTorr-300 mTorr. Depositions are preferably performed between about 10 mTorr and about 1 Torr total pressure. Plasma excitation was achieved via a 13.56 MHz RF source and attached matching network. The plasma was capacitively-coupled, with a powered upper electrode/showerhead and a grounded lower electrode, which also acted as the substrate stage.

Plasma excitation can be either continuous or pulsed. For continuous plasma deposition, power densities between about 0.07 W/cm² and about 2.6 W/cm² are preferably employed, with a power density of about 0.26 W/cm² found to often be suitable. For continuous-wave (CW) experiments, input power was varied between about 200 W to about 500 W. Polymerization under CW conditions resulted in a significant amount of visible gas-phase polymerization in the plasma sheath, which precipitated out of the gas phase as a fine white powder. For pulsed-plasma deposition, similar power densities can be used with various duty cycles. Peak power was held constant at 400 W. Herein duty cycle is meant as a ratio of plasma on-time/total cycle time, where both numbers are given in milliseconds. To facilitate comparison, the percentage of time that peak power is applied follows in parenthesis. Any duty cycle value between about 1% and about 50%, achieved via any ratio is in general acceptable. Duty cycles of about 10/10 (50%), about 10/40 (20%), about 10/90 (10%), and about 10/390 (2.5%) can be suitable for many applications. Duty cycles of were chosen so that they could be compared, in an equivalent power sense, to the experiments performed under CW conditions. Deposition times can range from about several minutes to over an hour, depending upon the power conditions used, as will be recognized. Deposition times used in the experiments ranged between 3.5 and 10 minutes, depending upon the power conditions used.

C. Fourier Transform Infrared Spectroscopy (FTIR) Analysis

Since one aspect of this invention is to create a plasma polymer that is as similar to a traditionally polymerized polymer as possible, FTIR analysis was used to screen the plasma polymerized samples. Those samples that did not correlate well with the standard PaMS sample (Nicolet Polymer Spectra Database) were not carried on for further analysis.

FTIR analyses of films produced in accordance with the process conditions described above were carried out on a Thermo Nicolet Nexus 870 ESP spectrometer in transmission mode. Spectra were baseline corrected and typically taken at 4 cm⁻¹ resolution averaged over 64 scans. All spectra were normalized to a thickness of 1500 Å using Beer's Law.

D. Variable Angle Spectroscopic Ellipsometry (VASE) Analysis

Variable Angle Spectroscopic Ellipsometry (VASE) was performed using a J. A. Woolam M-2000 spectroscopic ellipsometer, employing a xenon light source. Data were acquired at three angles (65°, 70°, and 75°) and 225 wavelengths, and the resulting data fit using the Cauchy-Urbach model.

E. Thermal Stability Analysis

Thermal stability analysis was performed using the ITS (Interferometry for Thermal Stability) apparatus. Samples were heated to 400° C. for two hours under a nitrogen atmosphere and then quenched to room temperature and analyzed.

F. Electrical Analysis

Electrical measurements were performed using a Mercury probe instrument from MDC. The Hg spot size was 790 microns, and three C-V measurements were performed for each sample studied. k values were calculated based on the average saturation capacitance values obtained, the film thickness (as determined by ellipsometry), and the Hg spot size.

G. Mechanical Analysis

Mechanical properties were measured by the MTS Nano Instruments Innovation Center in Oak Ridge, Tenn. Measurements of hardness and elastic modulus were performed using a Nano Indenter® DCM and MTS' patented Continuous Stiffness Measurement (CSM) technique. With this technique, each indent gives hardness and elastic modulus as a continuous function of the indenter's displacement into the samples. Ten indentations were performed on each sample. Loading was controlled such that the loading rate divided by the load was held constant at 0.05/sec. Experiments were terminated at a depth of approximately 500 nm. The tip used for these experiment was a Berkovich diamond tip. As a control, a sample of fused silica (amorphous SiO₂) was also tested. Samples were approximately 1 μm in thickness to minimize any effect of the substrate on the measurements.

Samples were mounted for analysis by the following procedure: Crystalbond®, a low-melting-temperature wax, was used to adhere a standard microscope slide to an aluminum stub. The stub and slide were allowed to come to room temperature. Five-minute epoxy was used to adhere the test sample to the microscope slide, taking care to ensure that the test area sat over the aluminum stub.

H. NMR Analysis

¹³C solid-state NMR analysis was performed using a customized spectrometer, consisting of a 6.338 T Oxford superconducting magnet and a 3.2-mm Chemagnetics magic angle sample spinning (MAS) probe. Approximately 12 mg of sample, collected from a number of identical runs, was scraped off of the silicon wafers and packed into a zirconia rotor of 11 mm³ internal volume. Both low molecular weight (LMW, Mₙ=790) and high molecular weight (HMW, Mn=4.0×10³) PaMS standards from Aldrich chemical were also ground into powders and packed into additional rotors for spectral comparison. Sample spinning at the magic angle of 54.7° was performed to mitigate spectral broadening. Sample spinning speed for ¹³C experiments was 15 kHz.

¹³C NMR experiments were performed with proton cross-polarization (CP) to enhance the signal and resolution. The ¹H-¹³C CP time was 3 ms, and the 90° pulse width was 1.3 μs. Time between successive scans was 30 seconds, and spectra were typically acquired for 8-12 hours. ¹³C spectra were externally referenced to tetramethylsilane (TMS).

I. Differential Scanning Calorimetry

Differential scanning calorimetry was carried out on a Perkin Elmer Pyris 1 Model DSC using the plasma polymer sample left over from NMR analysis, as well as the LMW and HMW PaMS standards (with known T_{g}'s) from Aldrich. Samples were prepared in 10 mL aluminum pans and heated between 25° C. and 100° C. at a heating rate of 10° C./min. The DSC was calibrated using Indium, with a known T_{g} of 156.8° C.

II. FTIR Analysis of V₃D₃/H₂O Films Deposited at Various Pulsed Plasma Duty Cycles

FIG. 1 shows the FTIR spectra of V₃D₃/H₂O films deposited in accordance with the invention at three pulsed plasma duty cycles. Incorporation of the H₂O into the film structure is readily apparent by the broad —OH stretching band between 3200 cm⁻¹ and 3700 cm⁻¹. The Si—O stretch from the Si—O—H group also gives rise to a strong band observed between 920 cm⁻¹ and 830 cm⁻¹. Note both bands increase in intensity with increasing pulsed plasma duty cycle, indicating a greater degree of —OH incorporation at higher applied powers. This increase in Si—O bonding is contrasted with a decrease in the intensity of bands associated with Si—C bonding in the 870 cm⁻¹ to 750 cm⁻¹ region, indicating that the OH groups are indeed bonding to the silicon atoms at the expense of some organic content. The Si—O—Si backbone absorbance appears between 1000 cm⁻¹ and 1200 cm⁻¹.

The rightmost peak, centered at approximately 1025 cm⁻¹, increases in intensity with the increase in pulsed plasma duty cycle and is associated with longer chain siloxanes or the formation of a networked structure. The leftmost peak, centered at approximately 1125 cm⁻¹, appears as a shoulder on the main peak and also increases in intensity with increasing plasma duty cycle. This band is often assigned as the ‘cage’ structure similar to a silsesquioxane. An increase in these bands with increase in plasma duty cycle is consistent with the increase in other Si—O specific bonding. Further increase in the intensity of these bands with annealing is evidence of Si—O—Si network and ‘cage’ formation during the annealing process.

FIG. 2 details the 1240 cm⁻¹ to 1300 cm⁻¹ region of the FTIR spectrum, where the Si—(CH₃)ₓ symmetric stretching band occurs. FIG. 2B shows the spectra for the same three films after annealing. The peaks in FIG. 2B have been shifted to higher wavenumbers with both increased duty cycle and annealing indicating a shift from ‘D’ to ‘T’ functionality and greater cross-linking. This significant shift from the ‘D’ rich structure to a more ‘T’-like structure is especially distinct in the lowest duty cycle (10-390) sample. Together with the disappearance of the —OH bands in the high wavenumber region, this shift can be attributed to condensation chemistry occurring between proximal Si—OH groups as outlined in Scheme I. This reaction leads to the creation of additional Si—O—Si linkages which are responsible for the increased quantity of ‘T’ groups and additional film crosslinking.

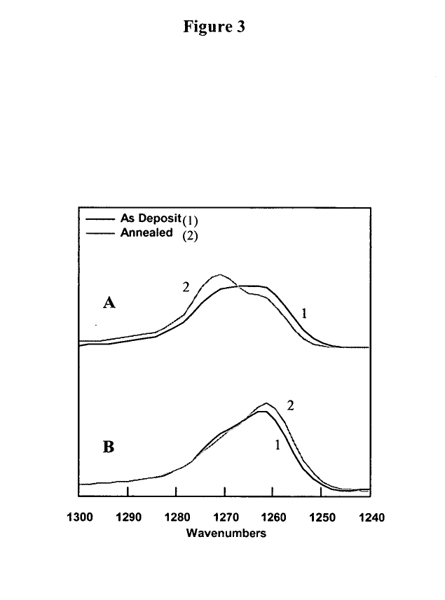

FIG. 3A shows the as-deposited and post anneal spectra of the 1240 cm⁻¹ to 1300 cm⁻¹ region for a film deposited from V₃D₃ and H₂O at a duty cycle of 10-390. For comparison, FIG. 3B shows the same region for a film deposited under the same conditions with argon substituted for water. Note that the sample deposited in the absence of water does not show a corresponding change in structure after the annealing step. The predominant band for both the as-deposited and post-anneal case in FIG. 3B is that associated with the ‘D’ group (˜1260 cm⁻¹). This would be expected given the cyclic structure of the precursor, which is basically comprised of ‘D’ type groups linked in a ring form. The fact that there is little change between the as-deposited and post-anneal spectra indicates that there is little chemical change occurring involving this moiety during the annealing step.

A final note is the lack of RCH═CH₂ (vinyl) specific bands in the FTIR spectra. If present, the vinyl CH₂ symmetric and anti-symmetric bands should be readily apparent above 3000 cm⁻¹. Additionally, the C═C stretching vibration should be visible at approximately 1650 cm⁻¹. The absence of these bands indicates a preferential cleavage of the Si—CH═CH₂ bond over the Si—CH₃ bond in the plasma. This is reasonable, given the greater disparity in electron density between the silicon atom and the vinyl group as compared to the methyl group. This condition is exploited in accordance with the invention to provide a ready site for formation of the Si—OH bonds. All FTIR assignments are summarized in Table I.

III. Mechanical Properties and Porosity of the Porous OSG Films

FIG. 4 shows the displacement vs. hardness curves for the as-deposited and post-anneal V₃D₃/H₂O samples. Solid markers indicate an annealed sample, open markers indicate an as-deposited sample. Note the increase in hardness with increasing duty cycle, which correlates well with the FTIR data showing an increase in crosslinking moieties in the film with increasing power. Additionally, for each sample, the annealed film is harder than its as-deposited counterpart, although the differences between as-deposited and post-anneal values for the 10-90 and 10-390 films are small. This supports the FTIR data that also shows an increase in crosslinking groups with annealing. Results are summarized in Table III. Also provided for comparison are the results for the V₃D₃/Argon film and fused silica. Interestingly, the V₃D₃/Argon sample had greater hardness values than either the 10-90 or 10-390 V₃D₃/H₂O samples.

TABLE III
Hardness and Modulus Results (Average Value Over Defined Range)

| | | Modulus (E) |
|---|---|---|
| Sample | Hardness (H) GPa | GPa |
| 10-40 As Deposit | 0.470 | 5.173 |
| 10-40 Annealed | 0.527 | 4.144 |
| 10-90 As Deposit | 0.204 | 3.938 |
| 10-90 Annealed | 0.202 | 2.338 |
| 10-390 As Deposit | 0.177 | 3.643 |
| 10-390 Annealed | 0.166 | 2.372 |
| V3D3/Argon 10-390 As Deposit | 0.200 | 3.732 |
| V3D3/Argon 10-390 Annealed | 0.239 | 3.271 |
| Fused Silica | 9.917 | 72.453 |

FIG. 5 shows the displacement versus elastic modulus for the as-deposited and post-anneal V₃D₃/H₂O samples. Solid markers indicate an annealed sample, open markers indicate an as-deposited sample. Results are again summarized in Table III. Similar to the hardness measurements (shown in FIG. 4), the elastic modulus values track well with duty cycle, with increasing duty cycle yielding higher values for the modulus. In the case of modulus, however, the annealed samples have a lower elastic modulus than their as-deposited counterparts. This is to be expected, since the annealed samples are understood to be more rigid and less able to ‘spring back’ after deformation, due the increased crosslinking and rigidity imparted to the film during the annealing process.

PALS is a useful technique for probing the free volume on an angstrom size-scale, between polymer chains. PALS is a non-destructive, radioactive technique in which the anti-particle of an electron is injected, from a radioactive source, into the OSG film. Upon ejection, a characteristic energy is given off for a measured amount of time. Within the OSG film, different mechanisms occur by which the positron, or species of positrons plus electrons, can decay. Regardless of which mechanism occurs, another characteristic energy is given out. The resulting decay curve can be fitted to a range of components including the lifetime of ortho-positronium (oPs) and its intensity. The lifetime, τ, is related to the size of the free volume, and the intensity is related to the number concentration of free volume sites. An approximate “size” of free volume can be determined and a measure of free volume fraction can be determined.

Positron annihilation lifetime spectroscopy (PALS) was used to determine the porosity of two OSG films produced according to the methods of this invention. One film was deposited at 400 W peak power with 10/40 ms-on/ms-off ratio to a thickness of 735 nm and the second film was deposited at 200 W peak power with 10/40 ms-on/ms-off ratio to a thickness of 560 nm. For both samples, the precursors used were V₃D₃ at 1 sccm, H₂O at 20 sccm, and methylmethacrylate at 10 sccm at a pressure of 300 mTorr. Following deposition, both samples were annealed at 400° C. for 1 hour under nitrogen. The PALS analysis was done several months after the deposition during which samples were stored at ambient conditions. The custom-built high vacuum chamber of the Michigan beam-PALS apparatus (Dr. David W. Gidley's laboratory) was used for the analysis. Beam energies range from 4.1 keV to 1.1 keV.

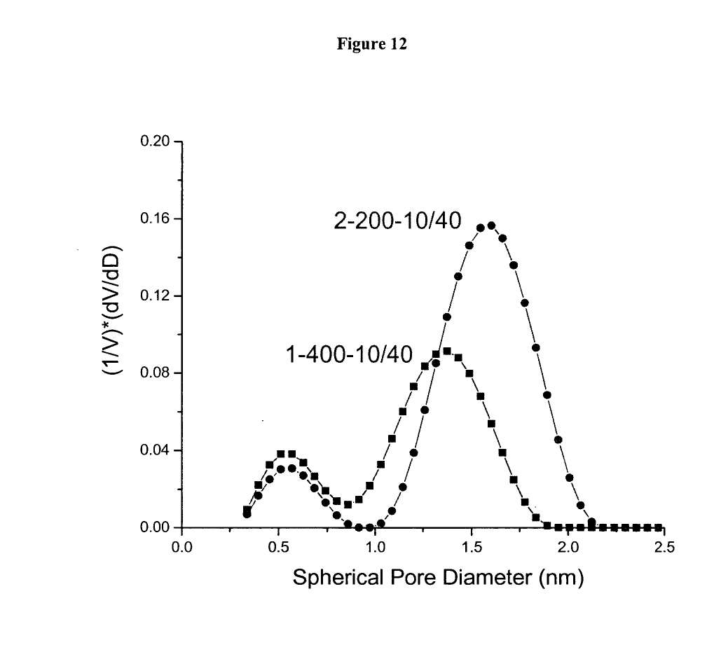

The raw PALS data are presented below in Table IV and the calculated pore size distribution is shown in FIG. 12. For both films the pores are either inherently “almost closed” or are largely sealed by post treatment. As shown in FIG. 12, the pores in the resultant film yield a bimodal distribution. The pores for the first OSG film analyzed, which was produced using 400 W peak power with 10/40 ms-on/ms-off ratio, centered around about 0.5 nm and about 1.4 nm. The pores for the second sample OSG film analyzed, which was produced using 200 W peak power with 10/40 ms-on/ms-off ratio, centered around 0.5 nm and 1.6 nm. The second sample spectrum was normalized to unity and the first sample spectrum was normalized according to relative total Ps formation intensity, which is one method for relative normalization. t,0340

IV. Thermal, Optical and Electrical Properties

The thermal and optical properties of the samples experimentally prepared as described above are detailed in Table V. All of the films were found to exhibit excellent thermal stability, with >95% thickness retention in all cases. Comparison of the CHₓ stretching region of the FTIR spectrum (3000 cm⁻¹-2800 cm⁻¹) for the as-deposited vs. post-anneal cases shows a minimal difference in intensity, suggesting that the organic content of the film is stable at the annealing temperature. Indices of refraction for the V₃D₃/H₂O films post-anneal are in the 1.42-1.43 range, down from the 1.46-1.47 range seen in the as-deposited samples. This is indicative of both the loss of H₂O/OH from the film, as well as a reduction in film density caused by the crosslinking and adoption of a networked Si—O—Si structure post-anneal. The V₃D₃/Argon film was found to not exhibit as significant a change in index, dropping to a post-anneal value of 1.454 from an as-deposited value of 1.475. This is consistent with a lesser degree of structural rearrangement and density reduction afforded by the inability to undergo condensation chemistry.

TABLE V
Thermal and Optical Properties

| | As Deposit | Post Anneal | Thickness | | |
|---|---|---|---|---|---|
| Sample | Thickness (Å) | Thickness (Å) | Retention | As Deposit n₆₃₃ | Post Anneal n₆₃₃ |
| 10-40 | 11112 ± 174 | 11029 ± 99 | 99.25% | 1.469 ± .005 | 1.423 ± .009 |
| 10-90 | 11246 ± 141 | 10882 ± 145 | 96.76% | 1.472 ± .004 | 1.426 ± .003 |
| 10-390 | 11245 ± 46 | 10770 ± 77 | 95.76% | 1.479 ± .009 | 1.432 ± .001 |
| V3D3/Ar 10-390 | 8257 ± 204 | 8152 ± 193 | 98.73% | 1.475 ± .006 | 1.454 ± .010 |

Dielectric measurements of the as-deposited films reflect the degree of OH and H₂O incorporation present. As-deposited k-values of 4.73, 3.96, and 3.49 were obtained for the 10-40, 10-90, and 10-390 samples, respectively. The trend of higher k-values with increasing OH/H₂O content is expected due to the high k-value of water, and tracks well with the FTIR results showing greater OH inclusion at higher duty cycles. Annealing the samples significantly reduced the dielectric constant of all of the films. Post-anneal k-values of 2.90, 2.62, and 2.61 were found for the 10-40, 10-90, and 10-390 films, respectively. Results are summarized in Table VI. For comparison, the 10-390 V₃D₃/Argon film had an as-deposited k-value of 3.06 and a post-anneal value of 2.55. For the V₃D₃/H₂O system the dielectric constant also correlated well with mechanical properties, with the hardest film (10-40) having the highest k-value (2.90). This can be attributed to the increasing Si—O content that is observed with increasing duty cycle and OH incorporation and the formation of an increasingly oxide-like structure.

TABLE VI
Electrical Properties

| Sample | As Deposit k | Post Anneal k |
|---|---|---|
| 10-40 | 4.73 | 2.90 |
| 10-90 | 3.96 | 2.62 |
| 10-390 | 3.49 | 2.61 |
| V3D3/Ar 10-390 | 3.06 | 2.55 |

V. Fourier Transform Infrared Spectroscopy (FTIR) Bands shift Dependant on Degree of Plasma Power Applied

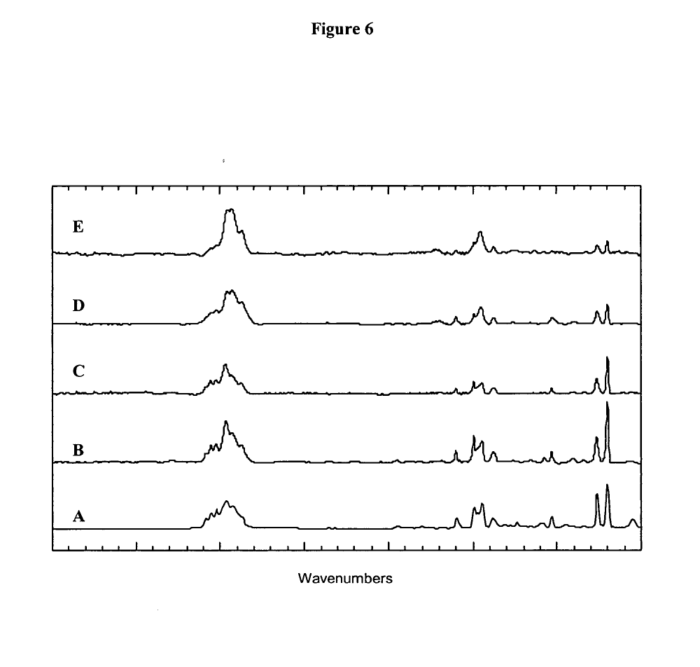

FIG. 6 shows the FTIR spectra of several PECVD films deposited under both pulsed and continuous conditions as compared to a standard sample. Table VII lists the major peak assignments and their literature assignments. All spectra have been baseline corrected and normalized to a standard 1500 Å thickness.

TABLE VII
FTIR Assignments from the Literature

| Assignment | wavenumbers (cm⁻¹) | notes |
|---|---|---|
| O—H stretching | 3400-3200 | broad |
| C—H stretching in subs. | 3100-3000 | often displays as triplet |
| aryl rings | | |
| CH₃ vibration | 2972-2952 | asym. str. |
| CH₃ vibration | 2882-2862 | sym. str. |
| CH₂ vibration | 2936-2916 | asym. str. |
| CH₂ vibration | 2863-2843 | sym. str. |
| Aryl C—H wag | 2000-1650 | weak, out of phase |
| | | wagging |
| C═O | ˜1700 | carbonyl |
| Quadrant stretch | ˜1600, 1580 | mono, di subst. |
| Skeletal C—C stretching | 1600-1585 | often displays as |
| | | doublet |
| Skeletal C—C stretching | 1500-1400 | semicircle stretch |
| CH₃ vibration | 1470-1440 | asym. bend |
| CH₂ vibration | 1475-1445 | scissor |
| C—H bending | 1300-1000 | aryl, in-plane bend |
| C—H bending | 1200-1145 | aryl, in-plane bend |
| C—O bending | ˜1110-1060 | C—O bending |
| C—H bending | 760, ˜700 | aryl, out-of-plane bend |

The two phenyl ring bending modes at 700 cm⁻¹ and 760 cm⁻¹ provide evidence of retention of the phenyl ring structure in some of the plasma deposited films. These bands shift in relative intensity depending upon the degree of plasma power applied. At high power (FIGS. 6D and 6E), these two bands have been significantly reduced, indicating a breakup of the phenyl ring. At the lower power condition (FIGS. 6B and 6C), these bands are much more prominent and are comparable in intensity to the same bands in the standard sample (FIG. 6A). Comparison between the samples deposited at similar power conditions (FIGS. 6B-6C and 6D-6E) shows that the phenyl bands are more intense in the pulsed-plasma samples, indicating that the CW conditions result in a greater loss of ring structure.

Also indicative of retention of the phenyl moiety are the three bands at 1465 cm⁻¹, 1495 cm⁻¹, and 1605 cm⁻¹, which all correspond to C—C skeletal ring stretches in substituted aromatic structures. The 1465 cm⁻¹ and 1495 cm⁻¹ bands typically appear as a doublet. These bands are present in all of the plasma-deposited samples. The two high power samples (FIGS. 6D and 6E) show a change in the relative intensity of the two doublet peaks, with the 1465 cm⁻¹ peak being favored. These bands are associated with movement of the skeletal structure as a whole (quadrant and semicircle stretches), and this change in intensity could be the result of constraints placed on the structure due to cross-linking or partial destruction of the ring. In the lower power samples (FIGS. 6B and 6C) these two peaks are of approximately equal intensity, as they are in the standard sample. The 1600 cm⁻¹ band varies in intensity similarly to the phenyl bands discussed previously, in that it is more prominent in the pulsed-plasma samples.

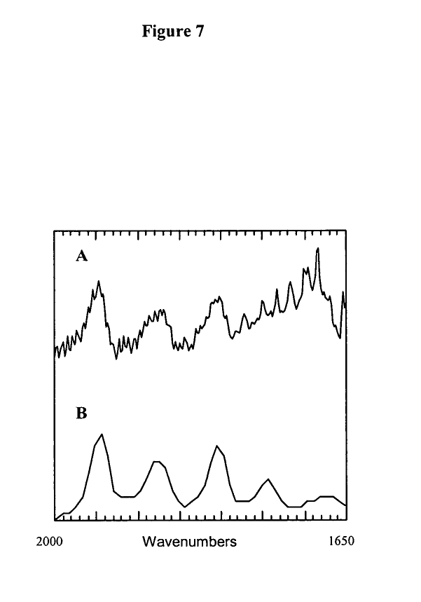

One of the most subtle, but telling, indicators of the aryl ring structure and its substitution pattern is in the small bands that arise between 1600 cm⁻¹ and 2000 cm⁻¹. These are the ring overtone bands, and their number and pattern can be a clear fingerprint of the ring substitution pattern. As seen in FIGS. 7A, the standard sample shows five small bands present in that spectral region, which corresponds to a monosubstituted aromatic ring structure, as would be expected in traditionally polymerized PaMS. Of the plasma-polymerized samples, only the 10/90 sample (FIG. 7B) also shows evidence of these ring overtones in the FTIR spectra. The absorption pattern is indicative of the substitution pattern on the aryl ring. Three of the five bands are present, and the other two are most likely obscured by peaks associated with a small amount of C═O present in the plasma polymerized sample. This indicates that with the correct choice of pulsed-plasma conditions it is possible to preserve even a high degree of fine structure not typically associated with a plasma polymer.

The high wavenumber region from approximately 2800 cm⁻¹ to 3100 cm⁻¹ contains bands for C—H stretching modes in CH₃ and CH₂ groups, as well as C-H stretches arising from the phenyl ring. The CH₃ and CH₂ symmetric and asymmetric stretches all lie below 3000 cm⁻¹. The samples deposited at high power (FIGS. 6D and 6E) show significantly larger bands for CH₂— and CH₃— type moieties, indicating a greater concentration of those groups. Because the methylene group can be considered a possible cross-linking group, this suggests that the films deposited at higher power are relatively more cross-linked than their counterparts deposited at lower powers. These cross-links could arise from bond formation between an aMS radical and a CH— radical created at a random point on the polymer chain while exposed to the higher power plasma conditions. Additionally, the absorption bands in this region, especially in the 200 W sample, are broader and less sharply defined in the high power samples. Increasing line width of FTIR peaks is typically indicative of a loss of homogeneity in bonding environments. The resulting heterogeneity of bonding environments in plasma films can result from network formation through multiple types of cross-linking.

Bands attributed to C—H stretches on the phenyl ring lie above 3000 cm⁻¹, and frequently present in monosubstituted rings in a triplet configuration. This combination of bands is readily seen in the standard sample and the low power films (FIGS. 6A, 6B, and 6C). The two samples prepared at higher power show a marked decrease in the intensity and resolution of these bands; in the 200 W CW sample they have lost all resolvability and present as a slight shoulder on the left hand side of the other CHₓ bands. This is consistent with the loss of aryl ring structure seen in other regions of the FTIR spectrum.

All of the samples were re-analyzed via FTIR after approximately 1 month of exposure to ambient conditions to see the effect of oxygen/water vapor exposure on the films. The results are shown in FIG. 8. Again, all spectra have been baseline corrected and normalized to a thickness of 1500 Å. All of the films show some degree of carbonyl (C═O, ˜1700 cm⁻¹) and hydroxyl (O—H, ˜3500 cm⁻¹; C—O, 1205-1125 cm⁻¹) inclusion in their structure. Given that these bands were not present in the spectra taken immediately after deposition, we can conclude that the incorporation occurred upon exposure to the atmosphere post-deposition. Comparison of the high power samples (FIGS. 8D-8E vs. 8B-8C) shows that the degree of carbonyl inclusion (˜1700 cm⁻¹) is higher at higher powers. This is consistent with literature data showing increasing oxygen inclusion post-deposition as a function of increasing deposition power. The amount of O—H inclusion also appears to be slightly greater in samples produced at higher powers.

VI. Solid-State Nuclear Magnetic Resonance (NMR) Spectroscopy of the PPECVD 10/90 Sample and Two Standard Samples

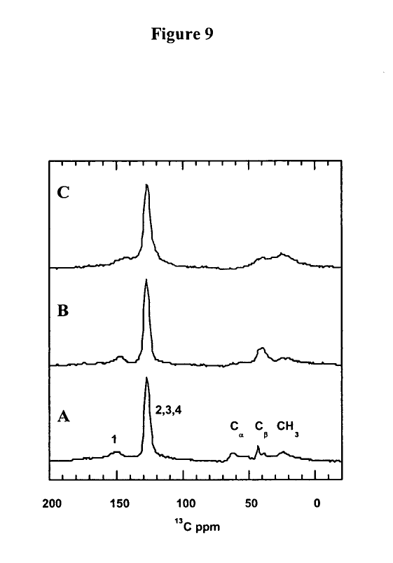

Because solid state NMR is time-consuming and requires larger samples relative to thin film volumes, only one deposited sample was analyzed by this method. Given the chemical similarity of the PPECVD 10/90 sample to the standard samples as evidenced by FTIR, solid-state NMR was performed on this sample as well as on two standard samples from Aldrich Chemical, representing a low-molecular-weight and a high-molecular-weight polymer. The spectra are compared in FIG. 9, and literature assignments of the chemical shifts are given in Table VIII.

TABLE VIII
NMR Assignments from the Literature

| assignment | ppm |
|---|---|
| CH₃ | 24-34 |
| CH₂ (C_{β}) | 40-45 |
| C(C₄) (C_{α)} | 54-64 |
| C₂₋₄ (aryl) | 125-128 |
| C₁ | 145-155 |

The spectra can be divided into two regions: aromatic carbons upfield from 100 ppm and aliphatic carbons downfield from 100 ppm. In the aromatic region there are two main resonances, at approximately 128 ppm and 150 ppm. The large resonance at 128 ppm is due to the unsubstituted carbon atoms in the ring structure, whereas the small peak at 150 ppm is attributed to the C1 ring carbon, where the ring is attached to the polymer backbone. The absence of any other resonances in this region confirms the FTIR analysis that the phenyl ring is intact and is not having its substitution pattern altered in the plasma.

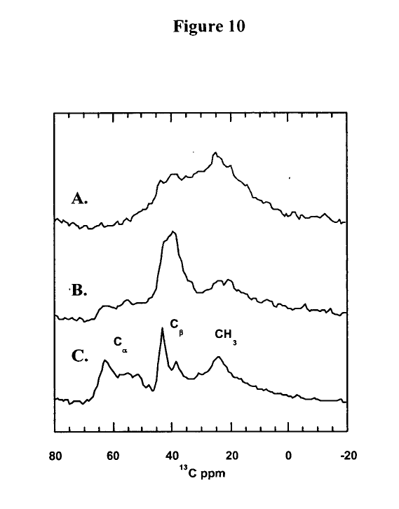

The aliphatic carbon region was fairly broad for all three samples, but did show three distinct regions, as detailed in FIG. 10. These resonances correspond to the alpha, beta, and methyl carbon environments. The peak at 25 ppm is attributed to the methyl (CH₃) groups, and was enhanced with the use of proton cross-polarization, as was the beta (CH₂) carbon, which resonates between 40 and 45 ppm. The alpha carbon, which should appear between 54 and 64 ppm, is a quaternary center and did not show any enhancement with proton cross-polarization, owing to its lack of proximity to neighboring protons. The alpha carbons were consistently difficult to elucidate in the spectra taken and are only clearly seen in the low-molecular-weight standard sample, even at recycle delays of up to 30 seconds between scans. This can most likely be attributed to a combination of the long spin-lattice relaxation time of the quaternary center coupled with the slow cross-polarization dynamics for carbons without adjacent hydrogens.

VII. Thermal Stability Testing of the Films

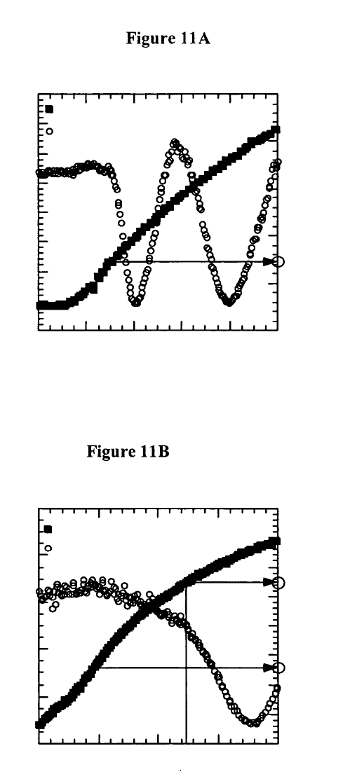

Thermal stability testing of the films was performed in a metal crucible under nitrogen atmosphere with a maximum temperature of 400° C. FIG. 11A shows the temperature-signal-time plot of the thermal stability test for the PPECVD 10/90 film. The onset of decomposition, taken to be the point where the signal curve begins to oscillate, occurs at approximately 75° C. Comparison of the pre- and post-anneal thicknesses of the sample via ellipsometry indicates a thickness retention of approximately 9%. This is in comparison to literature data that shows virtually no decomposition of PaMS below 300° C. for molecular weights between 3.7×10³ and 2.0×10⁵ and approximately the same heating rate. Differential scanning calorimetry of the 10/90 sample, performed between 25° C. and 100° C., shows a small transition near 38° C. This is in comparison to the observed transitions at ˜46° C. for the low molecular weight standard and ˜89° C. for the high molecular weight standard. Thermal stability results for the 40 W CW sample are similar, with the onset of decomposition occurring at about 65° C. Results are summarized in Table IX. Taken together, the thermal stability and DSC results suggest that the PaMS being produced at low plasma power is comprised mainly of non-cross-linked lower molecular weight oligomers. This supposition is also borne out by the fact that the plasma polymer can be solubilized in chloroform, just as the standard samples can.

TABLE IX
Thermal Stability Results for Plasma-Deposited Films

| | | | | |
|---|---|---|---|---|
| | As-Deposit | Post-Anneal | Decomp. | |
| Sample | Thickness | Thickness | Onset (° C.) | % Ret. |

| | | | | |
|---|---|---|---|---|
| 10/90 PPECVD | 7815 ± 164 Å | 730 ± 74 Å | ˜75 | 9.3% |
| 40 W CW | 3276 ± 421 Å | 0 Å | ˜65 | 0.0% |
| | | (Bare Si) | | |
| 10-10 | 10059 ± 73 Å | 4720 ± 96 Å | ˜125, 275 | 46.9% |
| PPECVD | | | | |
| 200 W CW | 2990 ± 329 Å | 1181 ± 56 Å | ˜170 | 39.51% |

The temperature-signal-time thermal stability plot for the PPECVD 10/10 sample is shown in FIG. 11B. Note the appearance of two possible decomposition regimes, one beginning at ˜125° C. and another at ˜275° C. Compared to the 10/90 sample, the onset of any decomposition is significantly higher: approximately 125° C. Additionally, there seem to be two regimes of decomposition occurring, as evidenced by the change in slope of the signal curve. The second phase of decomposition begins at approximately 275° C., where the signal curve begins its oscillatory behavior. Again, results for the 200 W CW are similar, but only show one decomposition regime with an onset of about 170° C. The behavior of the plasma films deposited under high power conditions can be explained by either the presence of longer chains of polymer, or a polymer that has a higher degree of crosslinking, both of which are possible given the higher plasma power involved. This is also supported by the increased intensity in the CH₂ bands in the FTIR spectra of these samples (FIGS. 6D and 6E). The two regimes of decomposition seen in the 10/10 PPECVD sample could be due to the desorption of small molecular weight species before the onset of bulk decomposition.

Those skilled in the art will appreciate, or be able to ascertain using no more than routine experimentation, further features and advantages of the invention based on the above-described embodiments. Accordingly, the invention is not to be limited by what has been particularly shown and described, except as indicated by the appended claims. All publications and references are herein expressly incorporated by reference in their entirety.

1. A method of fabricating a porous thin film comprising the steps of:
flowing a precursor gas comprising cyclic siloxane monomers in proximity to a substrate within a PECVD reactor;
adding a mild oxidant into the PECVD reactor, thereby partially oxidizing the cyclic siloxane monomers forming silanol groups;
depositing the silanol groups on the substrate; and
condensing the silanol groups, such that a porous organosilicate glass (OSG) film is formed.

2. The method of claim 1, wherein the step of flowing the precursor gas and the step of adding the mild oxidant are performed simultaneously.

3. The method of claim 1, wherein method further includes the step of subjecting the precursor gas to a plasma in the PECVD reactor.

4. The method of claim 3, wherein the plasma is pulsed and has an RF power density, a duty cycle, and a peak power.

5. The method of claim 4, wherein the RF power density is between about 0.07 W/cm² and about 2.6 W/cm².

6. The method of claim 4, wherein the peak power is set to between about 200 W and about 500 W.

7. The method of claim 4, wherein the peak power is set to about 400 W.

8. The method of claim 4, wherein the step of setting the duty cycle further includes selecting a percentage of time that peak power is applied that is between about 1% and about 50%.

9. The method of claim 1, wherein method further includes the step of subjecting the precursor gas to a continuous mode plasma in the PECVD reactor.

10. The method of claim 9, wherein the method further includes setting a RF power density to between about 0.07 W/cm² and about 2.6 W/cm² and setting an input power of the PECVD reactor to between about 40 W to about 500 W.

11. The method of claim 1, wherein the method further includes the step of selecting a monomer to oxidant ratio from between about 1:1 to about 1:100.

12. The method of claim 1, wherein the method further includes the step of selecting a monomer to oxidant ratio from between about 1:5 to about 1:20.

13. The method of claim 1, wherein the step of adding a mild oxidant into the PECVD reactor further comprises selecting a monomer to oxidant ratio such that the film has a desired dielectric constant.

14. The method of claim 13, wherein the monomer to oxidant ratio is selected such that the dielectric constant of the film is less than about 4.

15. The method of claim 13, wherein the monomer to oxidant ratio is selected such that the dielectric constant of the film is less than about 3.

16. The method of claim 13, wherein the monomer to oxidant ratio is selected such that the dielectric constant of the film is less than about 2.9.

17. The method of claim 13, wherein the monomer to oxidant ratio is selected such that the dielectric constant of the film is less than about 2.6.

18. The method of claim 1, wherein the cyclic siloxane monomers further comprise alkyl substituted siloxane molecules.

19. The method of claim 1, wherein the cyclic siloxane monomers can be selected from the group consisting of 1,3,5-trivinyl-1,3,5-trimethylcyclotrisiloxane (V₃D₃), 1,3,5,7-tetramethylcyclotrisiloxane (H₄D₄), 1,1,3,3,5,5-hexamethylcyclotrisiloxane, 1,3,5-triethyl-1,3,5-trimethylcyclotrisiloxane, and vinylalkylsiloxanes.

20. The method of claim 1, wherein the cyclic siloxane monomers are 1,3,5-trivinyl-1,3,5-trimethylcyclotrisiloxane (V₃D₃) molecules.

21. The method of claim 1, wherein the step of flowing the precursor gas further comprises setting the flow rate for the cyclic siloxane molecules at between about 1 sccm and 100 sccm.

22. The method of claim 1, wherein the step of flowing the precursor gas further comprises setting the flow rate for the cyclic siloxane molecules at between about 1 sccm and 20 sccm.

23. The method of claim 1, wherein the step of adding a mild oxidant further comprises selecting a mild oxidant from the group consisting of water, primary alcohols, peroxides, and N₂O.

24. The method of claim 1, wherein the step of adding a mild oxidant further comprises adding water.

25. The method of claim 1, wherein the step of adding a mild oxidant further includes setting a flow rate of between about 5 sccm and about 400 sccm.

26. The method of claim 1, wherein the step of adding a mild oxidant further includes setting a flow rate of between about 5 sccm and about 30 sccm.

27. The method of claim 1, wherein the step of condensing the silanol groups further comprises subjecting the substrate to a condition selected from the group consisting of heating, irradiating, or treating in a reactive plasma.

28. The method of claim 1, wherein the step of condensing the silanol groups further comprises heating the substrate to a temperature not higher than about 425° C. under inert conditions.

29. The method of claim 28, wherein the step of heating the substrate has a duration of between about 15 minutes to about two hours.

30. The method of claim 1, wherein the step of condensing the silanol groups further comprises heating the substrate to a temperature between about 400° C. to about 425° C.

31. The method of claim 1, wherein the step of condensing further comprises condensing under a condition selected from the group consisting of an inert atmosphere, a nitrogen atmosphere, and vacuum conditions.

32. The method of claim 1, wherein the film has at least 90% thickness retention.

33. The method of claim 1, wherein the film has an average connectivity number above a percolation threshold.

34. The method of claim 1, wherein the film has an average connectivity number above about 2.

35. The method of claim 1, wherein the film has an average connectivity number above about 2.2.

36. The method of claim 1, wherein the film has an average connectivity number above about 2.3.

37. An electronic structure having multiple conductor layers comprising at least one low dielectric OSG insulator with a network of nanopores in electrical communication with at least one of the conductor layers, the insulator formed by CVD deposition from an OSG precursor and a mild oxidant.
